(19) United States
(12) Patent Application Publication
(10) Pub. No.: US 2014/0361525 A1
(43) Pub. Date: Dec. 11, 2014

(54) Living Book- A book that encourages and allows readers to add their own creations to it

(71) Applicants: Kumud Majumder, Upper Saddle River, NJ (US); Wanda Ivette Saez, East Windsor, NJ (US)

(72) Inventors: Kumud Majumder, Upper Saddle River, NJ (US); Wanda Ivette Saez, East Windsor, NJ (US)

(21) Appl. No.: 13/911,022

(22) Filed: Jun. 5, 2013

(51) Int. Cl. B42D 1/00

(52) U.S. Cl. CPC B42D 1/003
USPC 281/38

(57) ABSTRACT

A book, printed or electronic, wherein one or more of the attached or detached covers or inside pages are blank or specially formatted to encourage reader(s) to be creative and incorporate new ideas, composition, drawings or any creations to the book. By adding their creations to the existing book readers produce personalized versions of existing book. Submission to book editors can be done using these pages or any other media. Inclusion of reader contribution gives the living book an assumed life, growing bigger with time. The readers are free to change the story line by addition/alteration, giving an opportunity to mutate any portion of the book. The living book format encourages children/adults, particularly sick and/or disadvantaged ones to creatively express their inner feelings and sufferings. It acts as a medical aid for improving psychological health of the patient. This application is pursuant to the provisional filings 61656481 and 61658934.

### CROSS-REFERENCE TO RELATED APPLICATIONS

This application claims benefit of U.S. provisional patent applications Ser. No. 61/656,481, filed Jun 06, 2012, and 61/658,934, filed Jun 13, 2012, which are herein incorporated by reference.

### BACKGROUND OF THE INVENTION

1. Field of the Invention

The invention relates to the field of books in general, and more particularly to children's books.

2. Description of Prior Art

As a way of inducing children to write and publish stories or other compositions, kits have been designed to fill up a pre designed book outline and then publish through the vendor providing the kit.

Such prior art has been somewhat successful in creating personalized books, which teach children to write books or create other art projects. For example, U.S. Pat. No. 7,654,575 provides a kit for an adult with a list of interview information obtained from a child and then use this in conjunction with pre determined computerized story line to create a personalized story involving the child.

A similar approach has also been taken by the company—Creations by You, http://www.creationsbyyou.com/IP/Consumer_Internet.asp. In this Internet based system a kit can be purchased by the customer to create a story that is submitted on line and then published by “Creations By you”.

The above kits provide a means of writing a story using an outline. But, it does not provide encouragement or means for the children or adult reader to add their creations to an existing book.

Books have also been published with diary like blank pages to help chronicle reader's experience. However, it would be desirable to further attract the interest of children and also adults in order to even better encourage their desire to write or draw not just for private consumption but also for sharing with public. Currently no method exists where a reader can provide his or her own twist or personal touch to an existing book or published material.

The current invention addresses this gap in the current state of art.

### SUMMARY OF THE INVENTION

It is an object of the invention to provide a book having features which attract the attention and interest of young children and also adults and encourage them to write or draw on themes related to the book or otherwise. The book might be published as printed or any of the known commonly used electronic formats.

This invention also provides a means to the readers to submit their creations for publication as part of the original book or otherwise. The new material might be submitted using written materials sent through traditional mailing systems, courier or electronically.

This invention creates a system of expanding on the scope of the work on the original author(s) through contributions by the readers. This invention also allows the reader to personalize the theme of the book and provide it a twist that might even alter the course of the original story or composition.

In essence, this invention provides a life to a book, making it live and grow beyond what has been created by the published book. Each new edition then contains additional work from the reader(s) that is added to the original book leading to a dynamic growth of the book. The same applies to stories, cartoons, or drawings published in other printed forms.

### BRIEF DESCRIPTION OF THE DRAWINGS

FIG. 1. A sample page as added to the book for use as submission page.

### DETAILED DESCRIPTION OF THE INVENTION

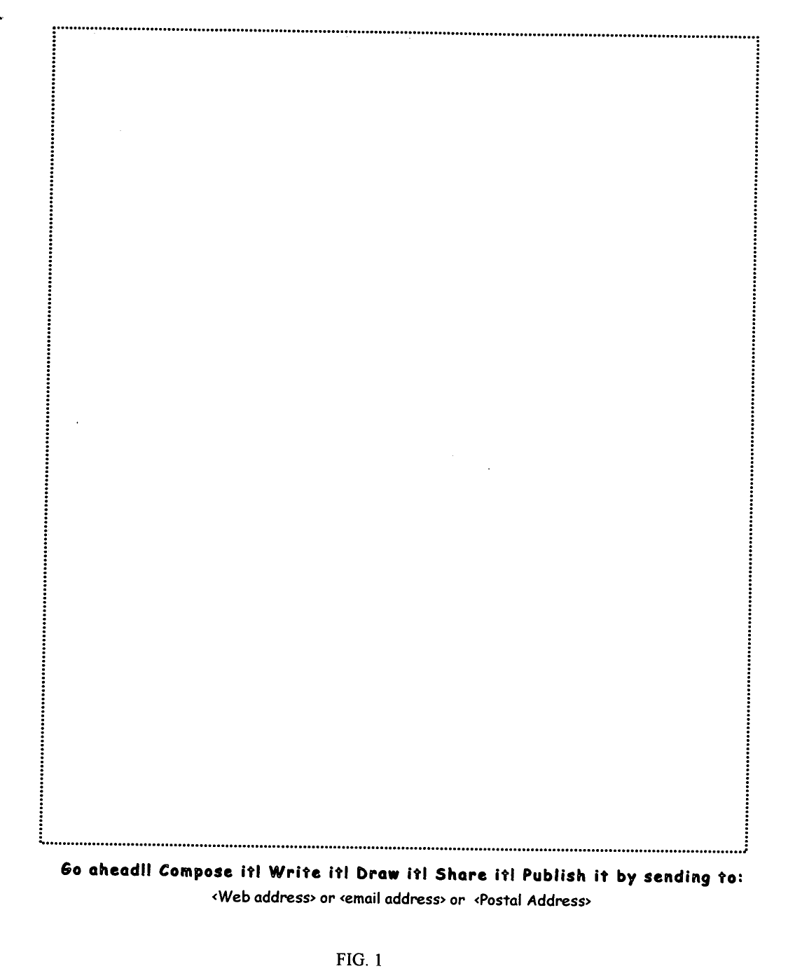

Referring to FIG. 1, a perspective view of a book in accordance with a preferred embodiment of the invention is illustrated. The book is a embodiment of a typical book that includes a front cover, a back cover, and a multiplicity of pages. The book might be published by traditional printed media or electronically. The current embodiment of the book includes blank or nearly blank pages (FIG. 1) that are added to the book to encourage the readers to be creative and express themselves through these pages.

FIG. 1 depicts one embodiment of the submission page wherein one or more addresses have been provided for submission to the editor by the reader. In a different embodiment these pages could be completely blank or contain a background template. In another embodiment the blank space might be contained in an otherwise partially filled page. The submission pages might or might not be easily removable or detachable from the book. The submission pages are added to make it easy for the young readers to write and/or draw.

Essentially the submission pages are designed to stimulate the creativity of the reader who can freely use these pages or any other writing/drawing material or media other than those attached to the book. The submission pages encourage the readers to use both traditional print and electronic media to record their creations and preferably submit to the editor of the book for inclusion in further edition of the book. Independent publication by the reader is also possible without violating any copyrights.

In one embodiment the submission pages could be created as computer or other forms of electronic files and submitted by any of the available postal or courier services or by electronic transfer.

It will be apparent to those skilled in the art that variations to the nature, location or presentation of the ‘submission’ pages are possible within the scope of the invention when used in combination with a book or magazine or journal or news paper.

In the foregoing specification, the invention has been described with reference to specific exemplary embodiments thereof It will, however, be evident that various modifications and changes may be made thereunto without departing from the broader spirit and scope of the invention as set forth in the claims. The specification and drawings are accordingly to be regarded in an illustrative rather than a restrictive sense.

What is claimed is:

1. A book in combination with:
a front cover, a back cover, and a plurality of pages there between, wherein one or more extra blank or partially filled or specially formatted pages are provided. The pages may or may not be easily removable from the book.

2. The book according to claim 1, wherein the book is published in printed or any of the available electronic formats.

3. The book according to claim 1, wherein the optionally removable submission pages are provided to encourage the reader(s) to be creative.

4. The book according to claim 1, wherein the encouraged reader(s) records his/her creativity in the submission pages, copy thereof or extra material. The creative material might or might not pertain to the original theme of the book.

5. The book according to claim 1, wherein reader(s) send their creations by regular postal mail, or any other letter/parcel service or electronically for inclusion in future editions or further publications.

6. The book according to claim 1, wherein reader(s) or the publishers use the enhanced work generated as in claim 4 for a book or similar publication.

7. The Book according to claim 1, wherein reader(s) and user(s) can collate contents from one or more Books or other electronic media and compose their own favorite collection of stories, poems and so on under a single Book compilation using their preferred order on content making this invaluable for attracting the attention of children and other readers.

8. The book according to claim 1, wherein reader(s) expand the scope of the original book through additive material thereby giving the book an assumed life or a living, growing book status.
